(19) United States
(12) Patent Application Publication
(10) Pub. No.: US 2021/0163183 A1
(43) Pub. Date: Jun. 3, 2021

(54) TAMPER-EVIDENT INSULATED BAG

(71) Applicant: Genpak Flexible L.P., Aurora (CA)

(72) Inventors: Bill Reilly, Aurora (CA); Scott Johnson, Innisfil (CA); Steve Sugden, Charlotte, NC (US)

(73) Assignee: Genpak Flexible L.P., Aurora (CA)

(21) Appl. No.: 16/818,314

(22) Filed: Mar. 13, 2020

Related U.S. Application Data
(60) Provisional application No. 62/818,924, filed on Mar. 15, 2019.

(51) Int. Cl. B65D 33/34; B65D 65/46; B65D 81/38; B65D 75/58; B65D 33/01; B65D 33/08; B65D 33/18

(52) U.S. Cl. CPC B65D 33/34; B65D 65/466; B65D 81/3888; B65D 33/18; B65D 33/01; B65D 33/08; B65D 75/5805

(57) ABSTRACT

An insulated bag includes an inner layer and an outer layer, a bottom, a score line, a handle, vents, and an adhesive that essentially irreversibly seals the bag. After sealing, the bag cannot be opened without incurring substantial damage, thereby providing a visual indication that tampering with the bag may have occurred. The insulated bag may be biodegradable and/or compostable.

### FIELD OF THE INVENTION

The present disclosure generally relates to insulated bags used to transport food.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, as listed below.

FIG. 1 is a perspective view of an embodiment of a closed and folded tamper evident insulated bag.

FIG. 2 is a perspective view of the bag of FIG. 1 with the edges disconnected and the bag shown in an extended position.

FIG. 3 is a cross-sectional view of the bag of FIG. 1 taking along cutting line 3-3 of FIG. 1.

FIG. 4A is perspective view of the bag of FIG. 1 in an open and standing position, prior to an item being placed therein.

FIG. 4B is perspective view of the bag of FIG. 4A in a closed and standing position, after having an item placed inside the bag and the bag being sealed.

FIG. 4C is a perspective view of the bag of FIG. 4B with the tamper evident seal removed via tearing at the score line. The tamper evident seal is shown upwardly offset from the rest of the bag.

FIG. 4D is a perspective view of the bag of FIG. 4C open such that the item placed inside the bag may be readily removed.

FIG. 5A is an enlarged view of the section encircled at 5A of FIG. 3 in an embodiment, illustrating the material of the bag in cross-section.

FIG. 5B is a cross-sectional view of an additional embodiment of an insulated tamper evident bag, similar to the view shown in FIG. 5A.

FIG. 5C is a cross-sectional view of a further embodiment of an insulated tamper evident bag, similar to the view shown in FIG. 5A.

FIG. 5D is a cross-sectional view of a yet further embodiment of an insulated tamper evident bag, similar to the view shown in FIG. 5A.

FIG. 5E is a cross-sectional view of a still further embodiment of an insulated tamper evident bag, similar to the view shown in FIG. 5A.

FIG. 5F is a cross-sectional view of an additional embodiment of an insulated tamper evident bag, similar to the view shown in FIG. 5A.

FIG. 6 is a perspective view of an additional embodiment of an insulated tamper evident bag.

FIG. 7A is an enlarged view of the section encircled at 7A of the bag of FIG. 6, illustrating a C-shaped vent in the closed position.

FIG. 7B is an enlarged view of the section encircled at 7A of the bag of FIG. 6, illustrating a C-shaped vent in the open position.

FIG. 8 a perspective view of an additional embodiment of an insulated tamper evident bag.

FIG. 9 is a perspective view of the bag of FIG. 8 with the edges disconnected and the bag shown in an extended position.

FIG. 10A is a cross-sectional view of the bag of FIG. 8 taken along cutting line 10A-10A of FIG. 8, showing the handle and vents coextensive with the bag.

FIG. 10B is a cross-sectional view of the bag of FIG. 8 taken along cutting line 10A-10A of FIG. 8, after the handle and vents have been pushed out slightly from the bag.

FIG. 11A is a perspective view of an additional embodiment of an insulated tamper evident bag.

FIG. 11B is a cross-sectional view of the bag of FIG. 11A taken along cutting line 11B-11B of FIG. 11A, showing a mechanical recloseable feature such as a plastic slider like Ziploc® zippers.

FIG. 11C is a cross-sectional view of a further embodiment of an insulated tamper evident bag, similar to the view shown in FIG. 11B but with hook-and-loop fasteners such as Velcro® fasteners.

FIG. 12A is a perspective view of an embodiment of a closed tamper-evident insulated bag in a flat, generally planar position.

FIG. 12B is a perspective view of the bag of FIG. 12A in a standing position, with the bag bottom extended and front and back walls substantially perpendicular to the bag bottom, and with the top end of the bag open with the inner portion of the bag readily accessible, prior to a first item being placed therein.

FIG. 12C is a perspective view of the bag of FIG. 12B, with the top end of the bag closed and the front and back walls sealed via a first adhesive.

FIG. 12D is a perspective view of the bag of FIG. 12C, with the tamper-evident seal removed via tearing at the score line. The tamper evident seal is shown upwardly offset from the rest of the bag.

FIG. 12E is a perspective view of the bag of FIG. 12D, with the tamper-evident seal completely removed from the bag and the inner portion of the bag readily accessible such that the first item placed inside the bag may be readily removed.

FIG. 12F is a perspective view of the bag of FIG. 12E with the top open and the inner portion of the bag accessible to hold a second item placed therein.

FIG. 12G is a perspective view of the bag of FIG. 12F containing a second item and with the top closed via a second adhesive.

FIG. 13 is a perspective view of an embodiment of a tamper-evident insulated bag having a viewing window.

FIG. 14 is a perspective view of an embodiment of a tamper-evident insulated bag having gussets.

FIG. 15 is a perspective view of another embodiment of a tamper-evident insulated bag having gussets.

It should be noted that these figures are intended to illustrate the general characteristics of methods, structure and/or materials utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by exemplary embodiments. For example, the relative thicknesses and positioning of components may be reduced or exaggerated for clarity. The use of similar or identical reference numbers in the various drawings is intended to indicate the presence of a similar or identical element or feature.

### DETAILED DESCRIPTION OF EXEMPLARY EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and may be exaggerated for clarity. The same reference numerals or the same reference designators denote the same elements throughout the specification.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including”, when used herein, specify the presence of stated features, integers, steps, operations, elements, and/or components, but do not preclude the presence or addition of one or more other features, integers, steps, operations, elements, components, and/or groups thereof.

Moreover, exemplary embodiments are described herein with reference to cross-sectional views, perspective views, and/or top or plan views that are idealized exemplary views. In the drawings, the thicknesses of some features may be exaggerated for clarity. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, a viewing window may be illustrated with sharp corners and without rounded or curved features even though such rounded or curved features may be preferable. Thus, the regions or elements illustrated in the figures are schematic in nature and their shapes may not necessarily illustrate the actual shape of a region or an element of a bag, and are not intended to limit the scope of example embodiments.

The embodiments of tamper-evident insulated bags disclosed herein relate to bags that may be used, for example, in the food industry. In particular, certain embodiments disclosed herein relate to insulated bags having a tamper-evident closure that may be used for storing and/or transporting hot or cold foods while maintaining their initial temperatures.

Insulated bags can be used by the restaurant industry for packaging one or more containers of food, such as take-out items or orders for delivery, while maintaining the temperature of the food. Such insulated bags may be used, for example, to transport hot or cold foods from a restaurant to a customer at a different location, ensuring that the food is delivered at or near the same temperature that it left the restaurant. The restaurant and/or customer may also desire knowledge that the food has not been altered or damaged during its transport. It would therefore be advantageous to have an insulated bag that has a tamper-evident closure for transporting food. As used herein, the terms “food” and “foods” includes beverages.

The bags disclosed herein contain a tamper-evident closure formed with a permanent adhesive that adheres the inner front wall of the bag to the inner back wall of the bag with such a high adhesion value that the inner front and back walls cannot realistically be separated without the material of the front and/or back wall tearing apart. That is, the substrates that are adhered together by the adhesive will mechanically fail before the adhesive fails. In this regard, the adhesive is considered to make an essentially irreversible seal between the portions of the bag to which it is applied, which are generally the front and back walls of the bag.

After sealing the bag in such an essentially irreversible manner, it cannot be opened without incurring substantial damage to the bag. An end user of the bag who wishes to access the bag contents after sealing, can either attempt to force the adhered bag walls apart (resulting in a bag with torn walls), or can remove the adhesive from the top of the bag by tearing along the score line (resulting in a bag with the top portion removed). Regardless of the manner in which the bag has been opened, it will be evident to the end user by simply viewing the bag, whether any tampering with the bag may have occurred since it was sealed.

Embodiments of the disclosed bags advantageously provide insulated food packaging that can incorporate biodegradable and/or compostable materials. The insulated bags also advantageously have a tamper-evident feature that is integral with the bag. Certain embodiments advantageously provide user friendly bags capable of maintaining hot or cold temperatures, that provide consumers with easy access to the products within the bags, and that have a dependable anti-tampering alert mechanism. Further details of embodiments of the disclosed bags are provided below.

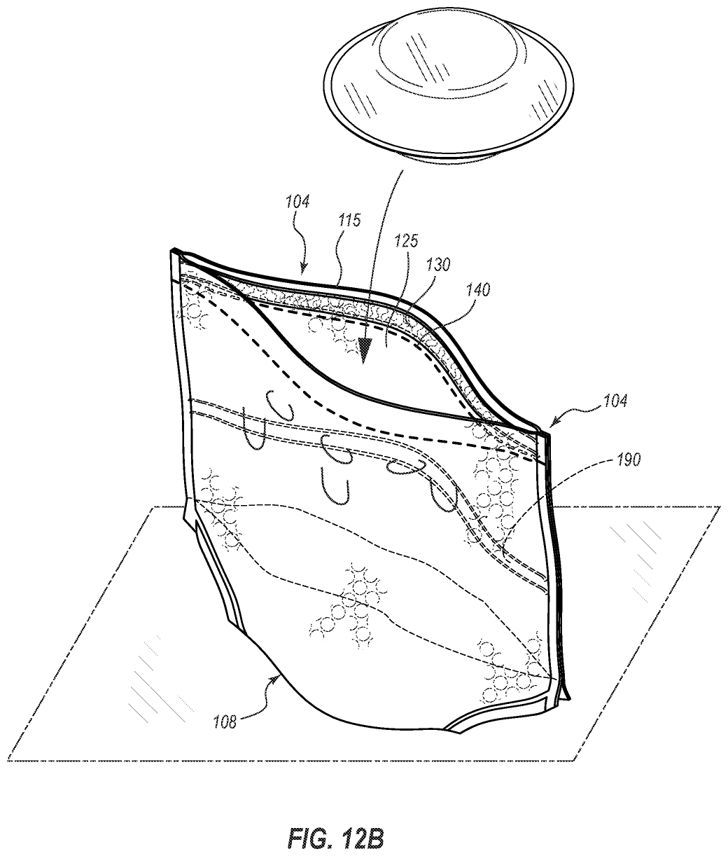

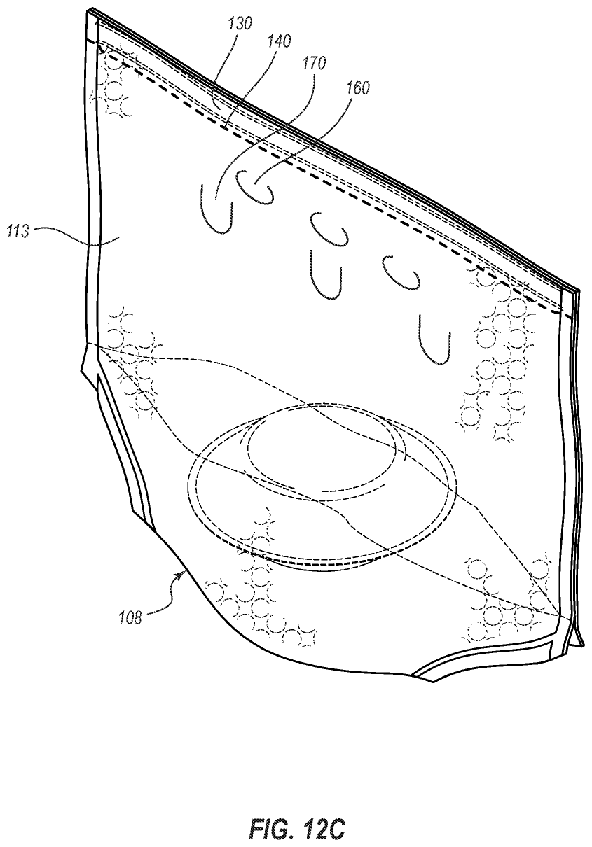

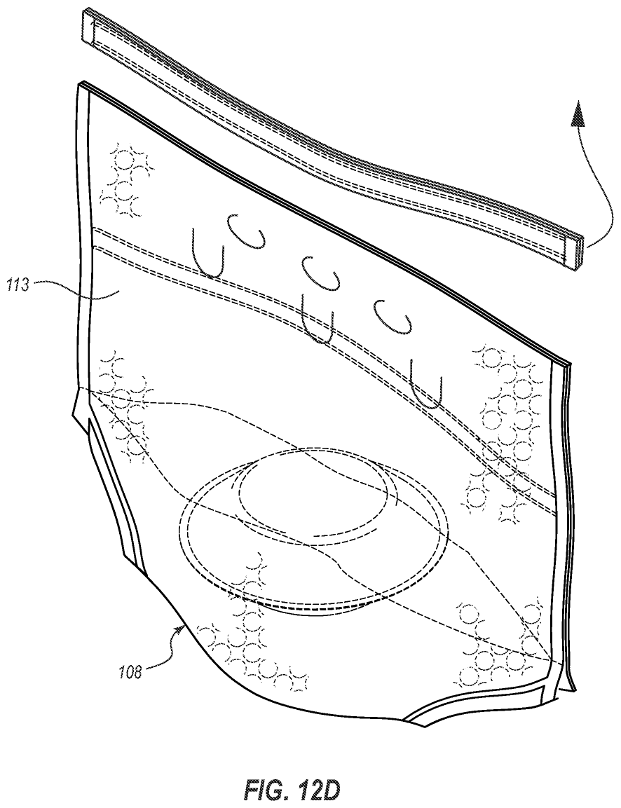

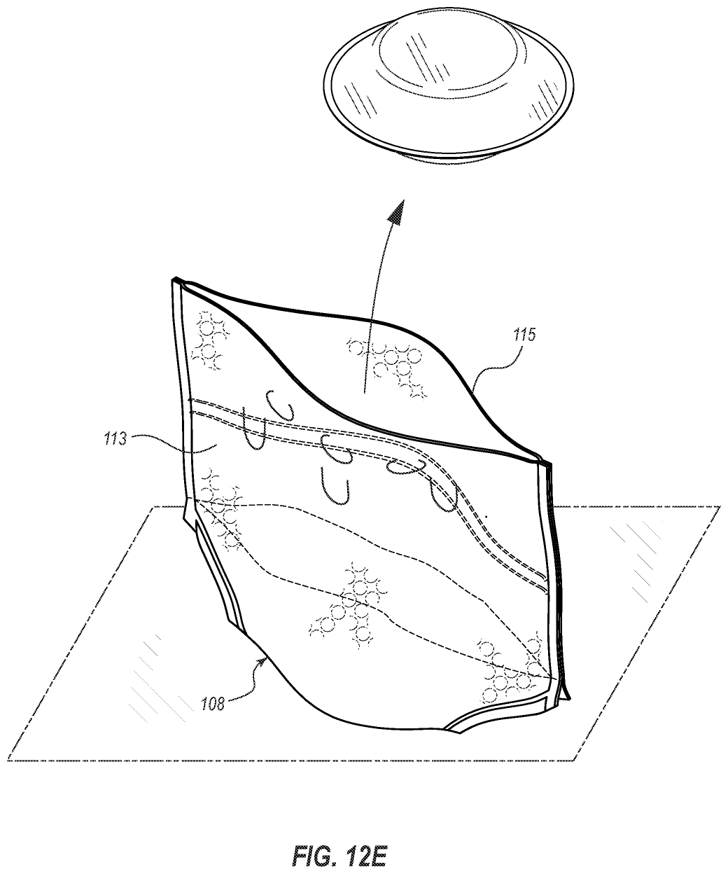

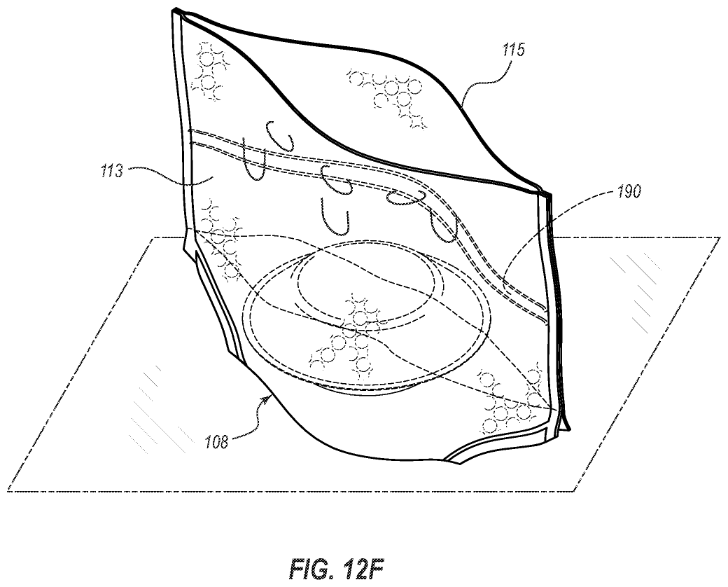

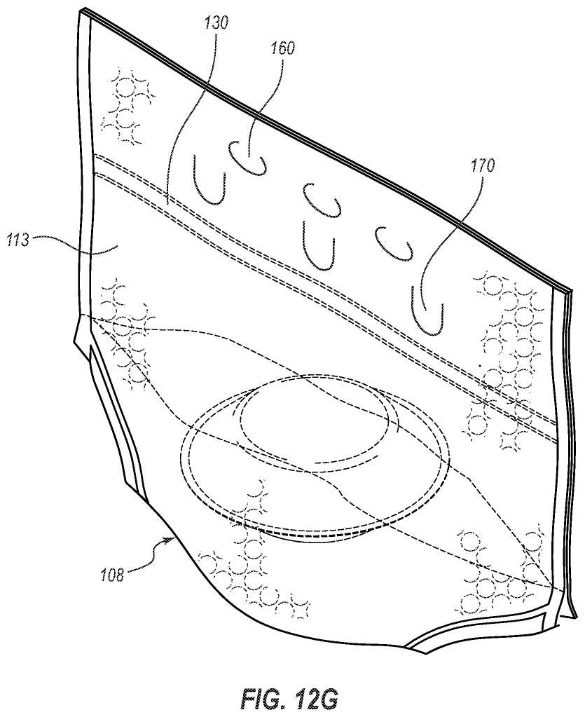

Certain embodiments of the insulated bags having a tamper-evident closure disclosed herein can advantageously be supplied to an initial user in an open, flattened preloaded configuration (e.g., FIG. 12A). The initial user can unfold the bag into an open standing configuration (e.g., FIG. 12B) to easily load the bag with any desired item, such as a container of hot food, and can then close and seal the bag (e.g., FIG. 12C). When in this state, the contents of the insulated bag may not be accessed without disrupting the tamper-evident seal and/or bag walls. The end user can, upon receipt of the insulated bag, tear off the tamper-evident seal to access the contents (e.g., FIG. 12D). Although the tamper-evident seal has been removed from the bag at this point, the bag may be reused to store or transport hot or cold items (e.g., FIG. 12G). The bag may be made entirely with biodegradable and/or compostable materials. Accordingly, in some embodiments, a consumer can ultimately have hot or cold foods delivered to them with assurance that the foods have not been altered during transport, in a bag that may be disposed of in an environmentally friendly manner.

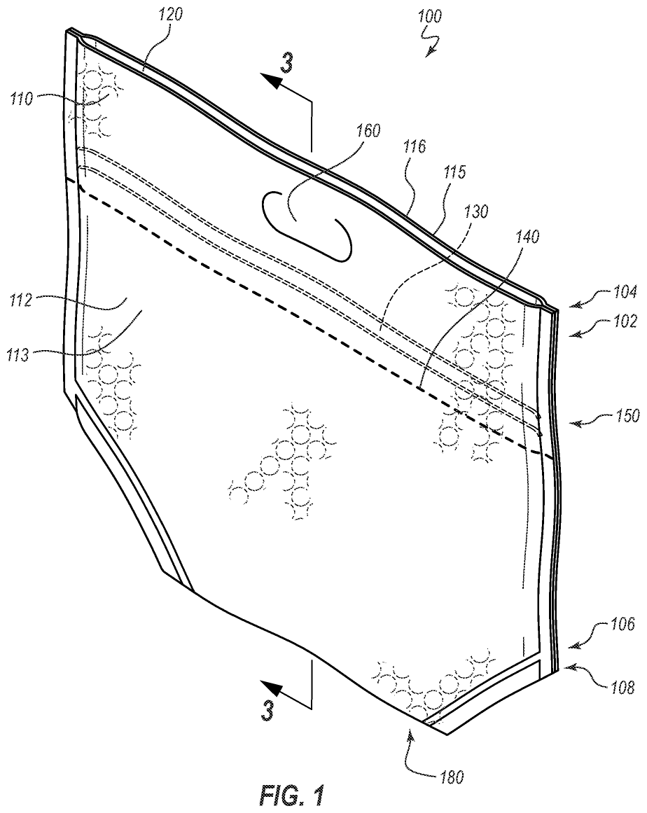

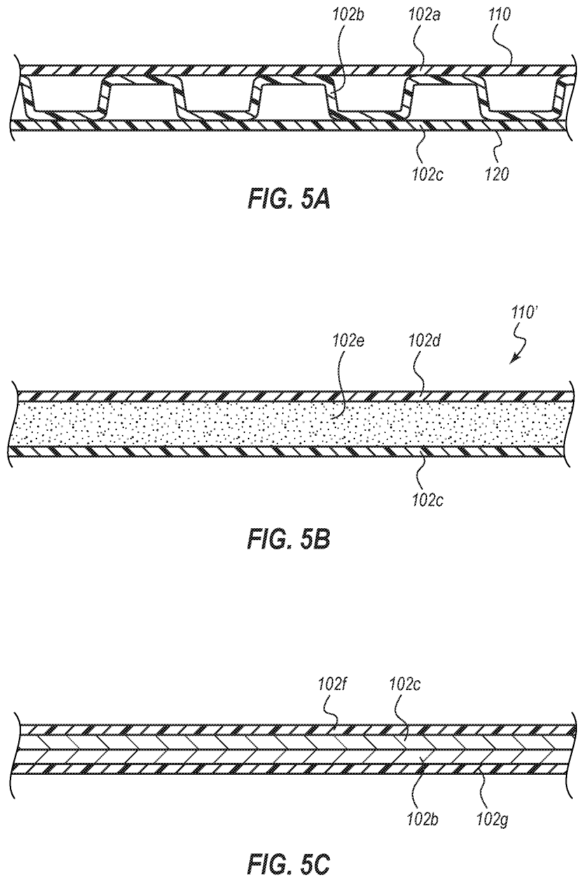

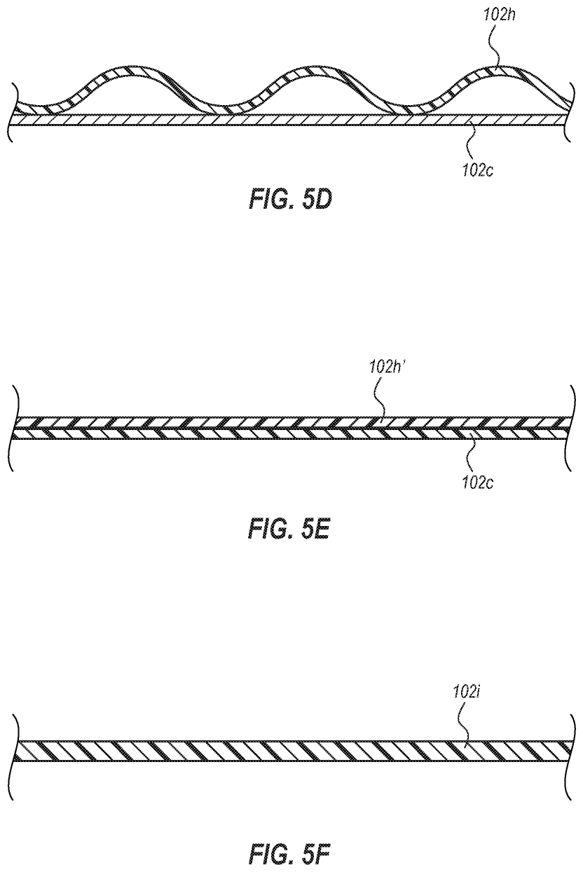

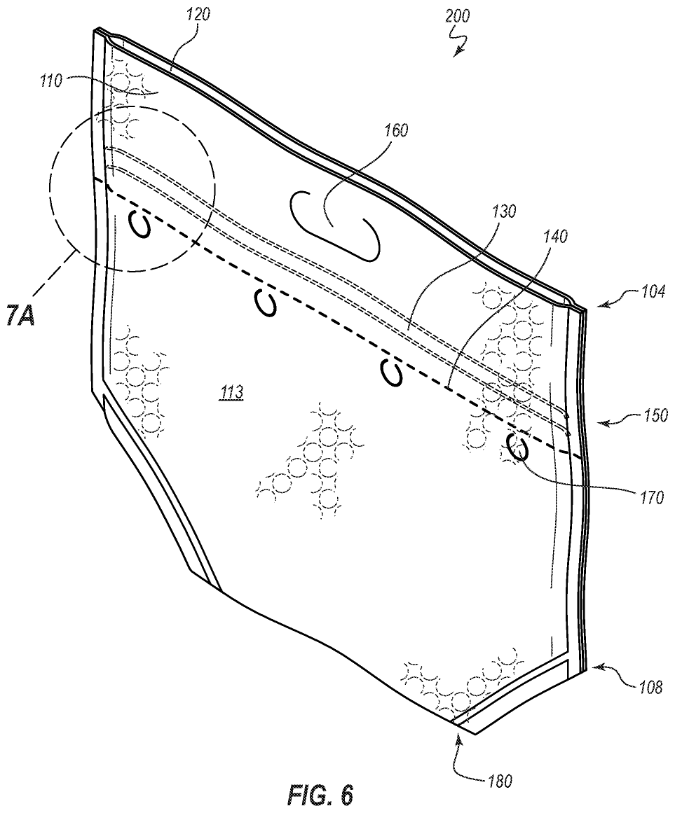

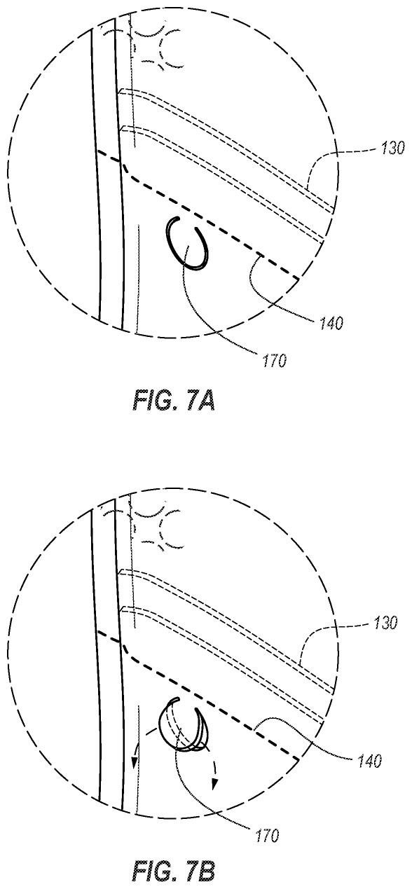

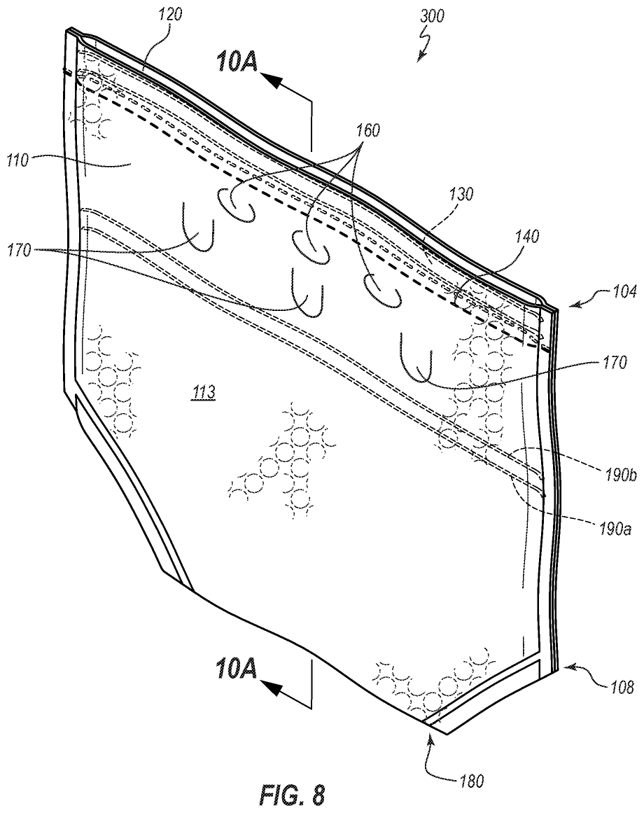

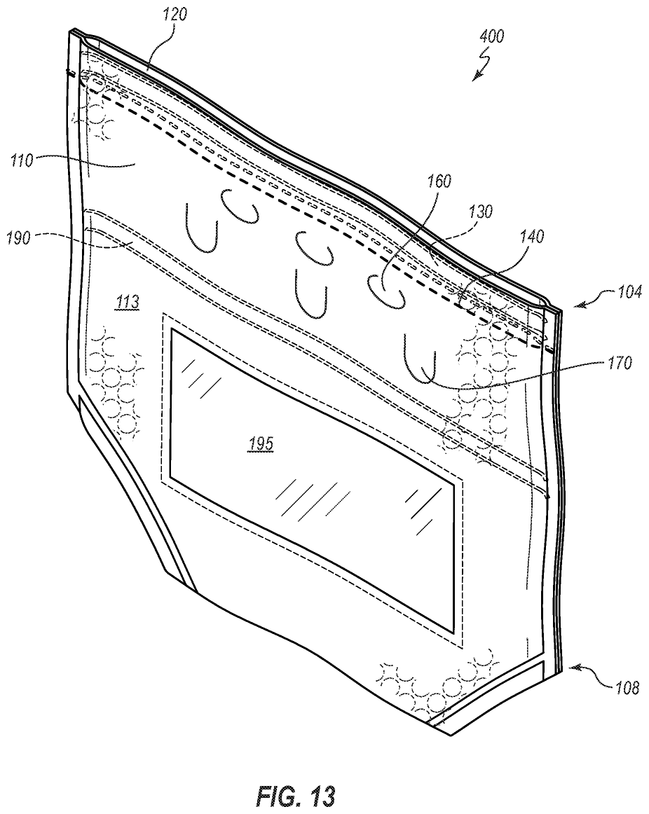

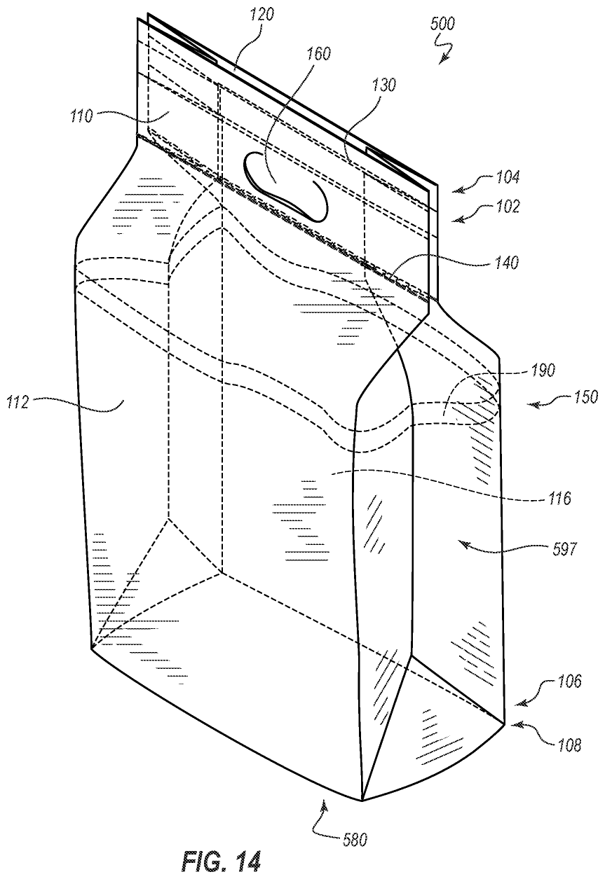

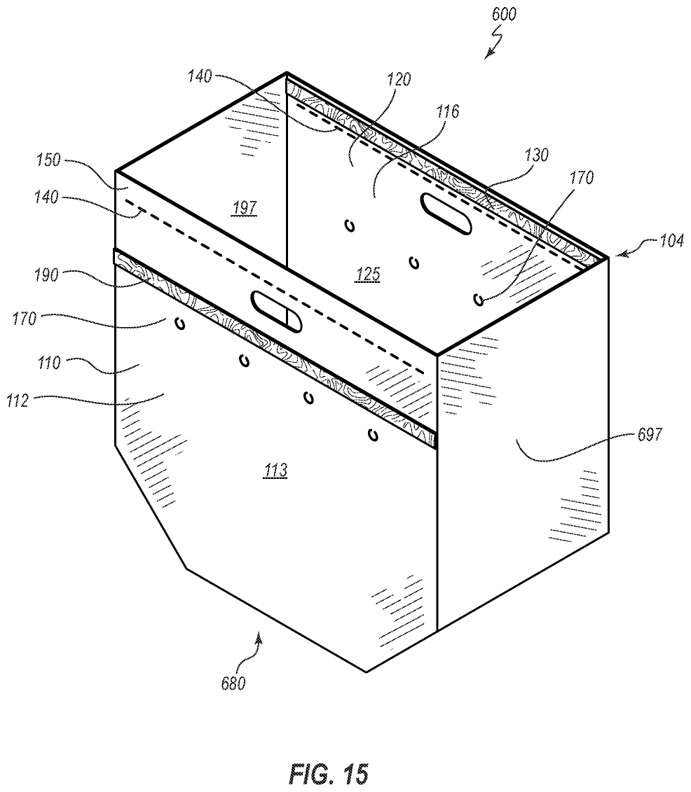

FIGS. 1-3 and FIGS. 4A-4D show an insulated bag 100 with several primary components or elements including an outer tube 110, an inner tube 120, an adhesive 130, a score line 140, a bag seal zone 150, a handle 160, and a bag bottom 180. Embodiments of the disclosed bags may also include a plurality of vents 170, an additional adhesive 190 and/or a viewing window 195. Other embodiments of a tamper-evident insulated bag are described with reference to FIGS. 5A-15. In particular, bag 200 is shown in FIGS. 6-7B, bag 300 in FIGS. 8-12G, bag 400 in FIG. 13, bag 500 in FIG. 14, and bag 600 in FIG. 15. The bags may have any suitable shape such as those that are rectangular, circular, and irregular shapes. Additionally, the bags may have any suitable size. For example, the bag may hold several containers such as three or four containers that are each about eight inches across in diameter. In some embodiments, the volume of the bag may vary from about 1000 inches³ to about 2000 inches³ and from about 1200 inches³ to about 1400 inches³. Additionally, the bag may be sized and sufficiently strong to hold about 3-55 lbs, 5-30 lbs, 8-12 lbs of food or about 10 lbs of food.

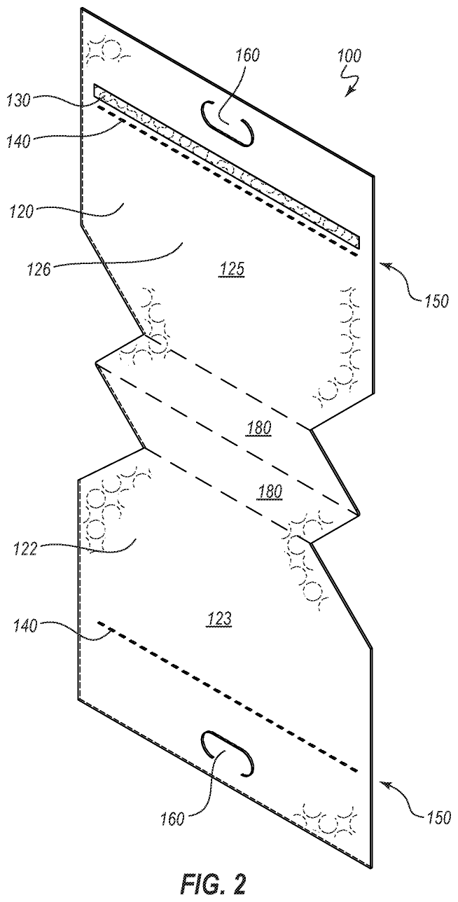

With reference to FIG. 1 and FIG. 2, insulated bag 100 includes outer tube 110, inner tube 120, bag seal zone 150 including adhesive 130 and score line 140, and handle 160. The bag 100 has an open end region 102 and a closed end region 106. The open end region 102 of bag 100 includes an open end 104 that provides access to inner portions of the bag 100, such as for a restaurant to load warm food containers into the bag for delivery to a remote customer. The closed end region 106 of bag 100 includes a closed end 108 and a bag bottom 180 that is typically adapted to stably rest upon a substantially planar surface, such as a tabletop or floor.

The outer tube 110 includes an outer front wall region 112 and an outer back wall region 116. The outer front wall region is positioned between the open end 104 and the closed end 108 of the bag 100. The outer back wall region 116 is positioned between the open end 104 and the closed end 108 of the bag, and is positioned to face opposite the outer front wall region 112. The outer front wall region 112 includes outer front wall 113, and the outer back wall region 116 includes outer back wall 115. The outer tube may include at its outermost position at least one layer of a paper or polymeric material that is printable and/or may include an opening or sleeve for printed material, such as a menu or advertisement. The outer tube 110 is positioned to substantially surround outer surfaces of the inner tube 120.

The inner tube 120 includes an inner front wall region 122 and an inner back wall region 126 positioned to face opposite the inner front wall region 122. The inner front wall region 122 includes inner front wall 123, and the inner back wall region 126 includes inner back wall 125. The innermost layer of material of the inner tube 120 may include a shelf or sleeve for placing small items, such as a napkins or disposable utensils. FIG. 2 illustrates the bag 100 in an extended and flattened view, with the edges unfastened and looking upon the inner tube.

One of the inner tube 120 and outer tube 110 may include at least one layer of material that has thermal insulating properties, and the material may be compostable. Various materials or chemical compounds can be used for the outer tube 110 and the inner tube 120. Preferably the materials of the outer tube and of the inner tube are selected from at least one of the following: a biodegradable material, a compostable material, a printable material, a metallized material, and an insulating material. The innermost material of the inner tube 120 is typically a food-grade material or GRAS material. The materials of the outer tube 110 and/or the inner tube 120 may have oil and/or grease resistance. Oil and grease resistance protects the contents within the bag 100 from the outside, while also protecting the outside from the contents.

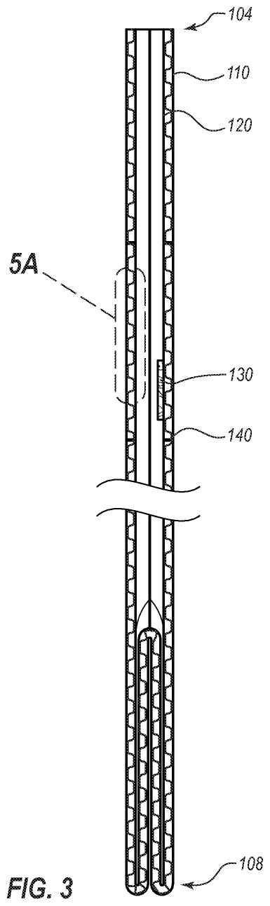

FIG. 3 depicts a cross-sectional view of the embodiment depicted in FIGS. 1-2 and the same embodiment is depicted FIG. 5A. In this embodiment, the outer tube 110 may include bubble wrap, which includes regularly spaced, protruding air-filled hemispheres (bubbles) to provide thermal insulating properties. When the outer tube 110 comprises bubble wrap, it is a combination of an outer layer 102a and an insulation layer 102b as depicted in FIG. 5A. The same embodiment depicted in FIG. 5A may include an inner tube 120 that is a metallized material layer 102c. The order may also be reversed such that the inner tube 120 includes bubble wrap while the outer tube 110 is a metallized material layer.

As noted above, the adhesive 130 is typically a permanent adhesive that is adapted to extend substantially the entire lateral extent of (that is, the entire circumference of) the inner tube at the top end 104, and that adheres the inner front wall of the bag to the inner back wall of the bag such that the inner front and back walls cannot be separated without the bag material tearing apart. Thus, the adhesive 130 is configured to form an essentially irreversible seal between and along the entirety of the front and back walls of the bag. Once the bag has been sealed via the adhesive 130, an end user can determine by viewing the condition of the bag (torn or damaged compared to unperturbed) whether any tampering with the bag may have occurred since the bag was sealed.

As used herein, the terms “seal,” “sealing” and “sealed” refer to closure of the insulated bag by the adhesive 130 along substantially the entire lateral extent of the inner front wall region 122 and the inner back wall region 126. Such closure involves essentially irreversible adhesion of the inner front wall 123 to the inner back wall 125 (and of any gussets, if present) with no gaps of more than about 0.5 inch in length along the inner circumference of the open end 104 of the bag 100.

As used herein, the term “essentially irreversible” refers to an adhesive that adheres the inner front wall of the bag to the inner back wall of the bag such that the inner front and back walls cannot be separated without the bag material tearing apart.

The adhesive 130 ensures that inner surfaces of the inner front wall region 122 of the inner tube 120 abuttingly contact and seal to inner surfaces of the inner back wall region 126 of the inner tube 120. The adhesive 130 may be a pressure-sensitive adhesive or a contact adhesive. The adhesive 130 may be applied to the inner front wall region 122 and/or inner back wall region 126 in a linear fashion, such as an adhesive strip having a protective sheet of material placed upon it so that the adhesive is not inadvertently exposed until the protective sheet is removed. After the bag 100 has been loaded with the desired contents, such as containers of food, the protective sheet may be removed and the inner surfaces of the front wall region 122 and the back wall region 126 may be pressed together to seal the open end 104 of bag 100.

The adhesive 130 may extend around all or a portion of the interior circumference of the open end 104 of the bag 100. For example, an adhesive 130 may extend substantially the entire lateral extent of and along the inner front wall region 122 and inner back wall region 126 of the bag 100. Such an arrangement may be useful when, for example, the adhesive is a contact adhesive that is applied to both surfaces that are being adhered. In an embodiment, the adhesive 130 may extend the partial lateral extent of and along the inner front wall region 122 and back wall region 126 of the bag 100. This arrangement may be useful when, for example, the adhesive is a pressure-sensitive adhesive that is applied to only one of the surfaces that are being adhered. The adhesive may, in some embodiments, extend approximately half of the lateral extent of and along the inner front and back wall regions of the bag. For example, the adhesive 130 may be applied only to the inner front wall region 122 of the bag or only to the inner back wall region 126 of the bag. Upon adhering the inner front wall to the inner back wall, however, an adhesive 130 that initially extends approximately half of the lateral extent of and along the inner front and back wall regions of the bag will ultimately extend substantially the entire lateral extent of and along the inner front wall region 122 and inner back wall region 126 of the bag 100, to sealingly close the bag 100.

The adhesive strength of the adhesive 130 may vary, and may be in part dependent upon the materials used to form specific embodiments of the bag 100. A stronger adhesive may be more suitable to seal bags made of stronger materials in an essentially irreversible manner, as compared to bags make of weaker materials, because the adhesive need only be stronger than the tear strength of the materials used to form the walls of the bag. For example, bags made with materials having a low tensile strength, such as newspaper (about 1-2 kN/m) or brown paper (about 2-50 kN/m) can be essentially irreversibly adhered with an adhesive having a lower adhesive value, as compared to insulated bags made with materials having a higher tensile strength, such as high density polyethylene (about 37,000 kN/m) or Kevlar (about 3,760,000 kN/m).

The adhesive 130 may extend along the inner front wall 123 and back wall 125 of the bag. As mentioned, the adhesive may be a pressure-sensitive adhesive or a contact adhesive. In some embodiments, the pressure-sensitive adhesive may be a strip of pressure-sensitive adhesive having a protective sheet of material placed upon it. The adhesive may extend partially the lateral extent of and along the inner front wall region 122 and back wall region 126 of the bag, such as along only the inner back wall region 126 of the bag. Other manners of adhering the inner front and back wall regions of a bag will be known to those of ordinary skill in the art and are to be considered within the scope of the present disclosure.

The adhesive 130 may be applied to the inner tube 120 of bag 100 in any suitable format. In certain embodiments, the adhesive is applied as a lateral strip of adhesive that is between about 0.1 inch and about 1 inch wide and that extends along the inner back wall region of the bag. Such a lateral strip may be positioned so that it extends substantially parallel to, or collinearly with, the open end of the bag. In an embodiment, the lateral strip extends substantially the entire lateral extent of and along the front and back wall regions of the bag. In an embodiment, the lateral strip extends substantially the entire lateral extent of the back wall 125 of the bag. The adhesive may be applied as a series of dots or ovals in a two-dimensional pattern, or it may be applied as a straight or a wavy solid line, or as a dashed line.

The adhesive 130 may be positioned at any location in the inner tube 120 between the open end 104 of the bag 100 and the closed end 108. In an embodiment, the adhesive 130 is positioned between the open end 104 and the handle 160. In some embodiments, the adhesive 130 is positioned between the open end 104 and the score line 140 such as in FIGS. 8, 11 and 13. The adhesive 130 may be positioned in a generally straight line that is parallel to (or collinearly with) the edges of the front and back walls of the bag at the open end 104, and along all of, along half of, or along a substantial portion of the inner circumference of the open end 104. The center of the line of adhesive 130 may be placed between about 0.5 and about 5 inches below the open end 104 of the bag 100. For example, the center of the line of adhesive 130 may be positioned about 3 to about 4 inches below the open end 104 of the bag 100, such as about 3.5 inches below the open end 104.

In an embodiment, the adhesive is a commercially available adhesive such as standard hot melt adhesives applied via a hot melt applicator. For example, the adhesive may include any adhesive used with polyethylene-based materials.

The score line 140 may be formed from removing or perforating the bag material in a well-defined pattern, typically a line, and is adjacent the adhesive material. The score line 140 ensures that the removal of the adhesive 130 to efficiently separate it from lower portions of the bag 100 occurs in the proper location and in an organized manner to provide access to the inner contents of the bag 100 and to visibly indicate that the bag 100 has been unsealed.

The score line 140 is generally placed underneath (that is, in a direction toward the bag bottom 180) the adhesive 130. The score line 140 may, in certain embodiments, be positioned adjacent the handle 160. For example, when viewing the bag 100 with the open end 104 at the top and moving toward the bag bottom 180, a strip of adhesive 130 may be positioned above the score line 140, which is positioned above the handle 160, which is positioned above the plurality of vents 170.

The score line 140 may be formed by either complete or partial removal of the material (including both the outer tube 110 and inner tube 120) from the bag 100 in an overall linear pattern. Such removal of the material may occur during manufacture of the bag as, for example, a frangible tear line, a line of perforation, and/or a region of reduced bag thickness. In certain embodiments, the score line 140 permits the controlled separation of the adhesive 120 from a neighboring portion of the bag 100, as initiated by a user of the bag. The removal of the essentially irreversible seal via separation of the adhesive 130 from the bag 100 by a user in an on-demand and visually evident manner is a benefit of the insulated bags disclosed herein.

The score line 140 may be of any length and thickness suitable for the bag 100. For example, the score line 140 may be a line of oval holes formed by a rotary pinned perforation roller, a die and punch, or a laser. In an embodiment, each hole is between about 1 mm and about 10 mm long, such as between about 2 mm and about 5 mm long, or about 3 mm long, and between about 0.05 and about 8 mm wide, such as about 0.5 mm wide.

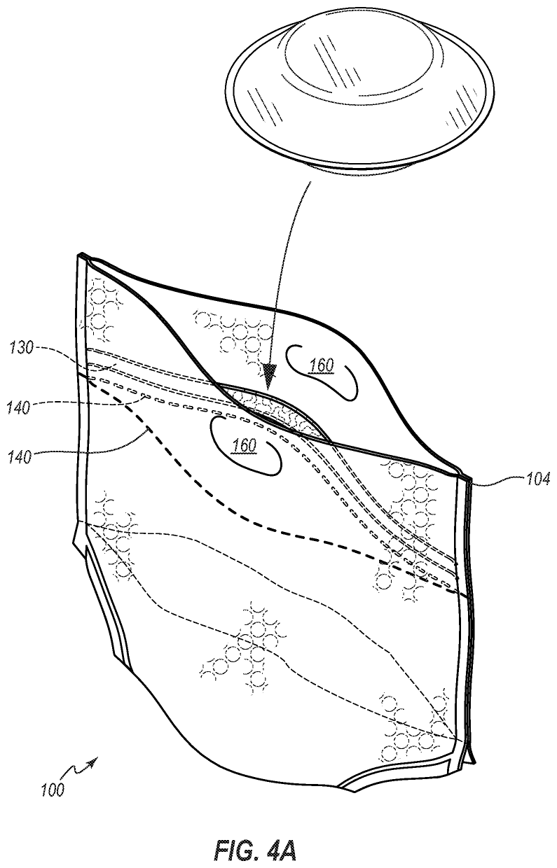

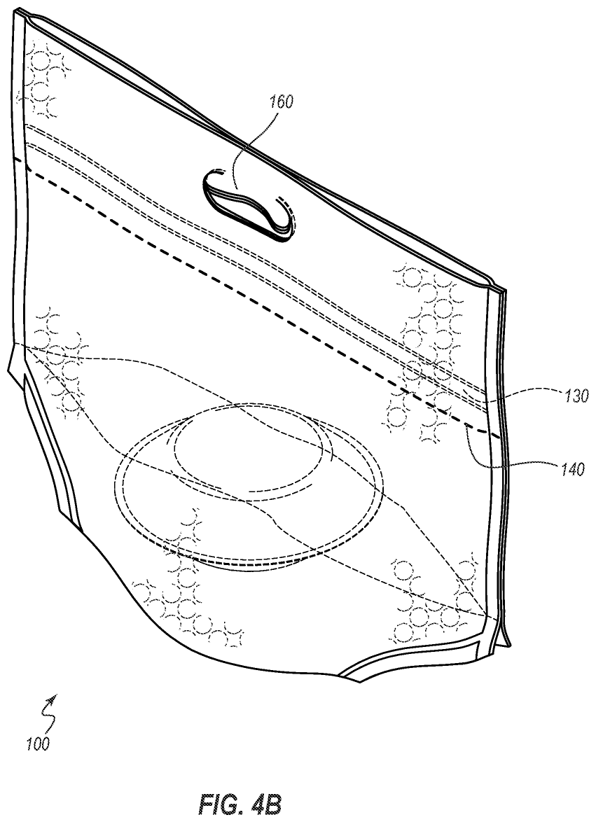

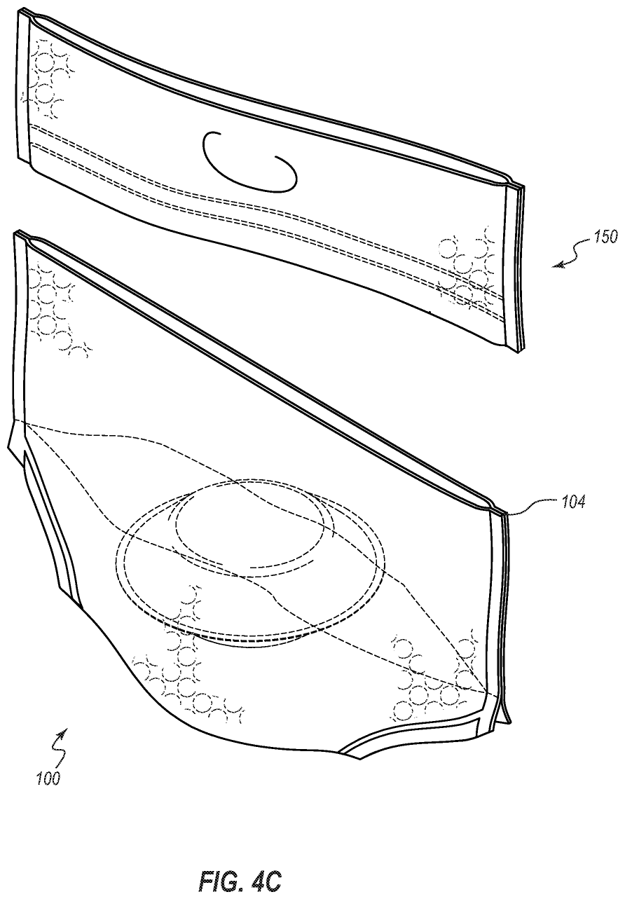

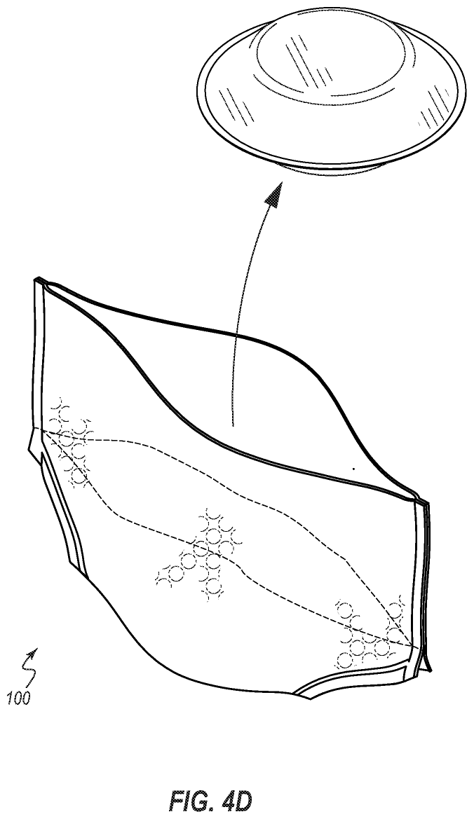

The bag seal zone 150 is formed adjacent the open end 104 of bag 100 so that the material of the inner surfaces of the inner front wall region 122 of the inner tube 120 abuttingly contact and seal to inner surfaces of the inner back wall region 126 of the inner tube 120. In an embodiment, the bag seal zone 150 includes the adhesive 130 and the score line 140. As noted, an end user can access the contents of the bag 100 after the top end 104 has been sealed via the adhesive 130 by tearing along the score line 140. The bag seal zone 150 can be closed using the adhesive 130 to create an essentially irreversible seal that is positioned below the open end 104 and above the closed end region 106, such as shown in FIG. 4B.

Several advantages exist with the insulated bags disclosed herein. One advantage is that the bag seal zone 150 of the bag 100 provides users with an indicator to determine if the bag 100 has already been open. This indication alerts consumers of possible tampering of with the bag 100. The bag seal zone 150 also, in certain embodiments, may protect the adhesive 130 that is used to seal the bag 100.

The insulated bag 100 may include a handle 160 that is integral to the front and back walls, as shown in FIGS. 1-2, 4A-4C, 6, 8-11A, and 12A-15. The handle 160 enables consumers to better handle the bag, including for transport and/or delivery. The handle 160 may be used by a consumer to easily grasp the bag 100 for transport to another location. The handle 160 may be formed as a single hole or as a plurality of holes in the bag that are adapted to fit up the fingers of a consumer. For example, the handle may be an oval hole that extends through and along the outer front wall region and the outer back wall region (e.g., FIG. 1). The material removed from the bag 100 to form the handle 160 may be entirely removed from the bag 100, or it may be partially removed from the bag 100. For example, the handle 160 may be formed using a die and punch process that cuts only partially around the circumference of the oval, such as about 70% of the circumference to form a flap that remains attached to the top edge of the handle 160. Embodiments of an insulated bag 100 may include a flap, also known as a chad, which is formed by a score line and is then easily pushed aside by a user's fingers when grasping the bag, and thus need not be completely removed from the bag 100. Other ways to form the handle will be known to those of ordinary skill in the art and are to be considered within the scope of the present disclosure.

The handle 160 may be of any length and width suitable for the bag 100. For example, the handle 160 may be an oval hole formed by a rotary pinned perforation roller, a die and punch, or a laser cutter. In an embodiment, the handle 160 is a single oval having a length between about 3 inches and about 8 inches, such as between about 4 inches and about 7 inches long, or about 5 inches long, and between about 0.5 inches and about 1.5 inches wide, such as about 1 inch wide. In some embodiments, the handle 160 is a series of three ovals (e.g., FIG. 8), each having a length between about 1 inches and about 3.5 inches, such as between about 1.5 inches and about 3 inches long, or about 2.5 inches long, and between about 0.5 inches and about 1.5 inches wide, such as about 1 inch wide.

With reference to FIGS. 4A, 4B, 4C and 4D, a container of food may be placed into the bag 100 through the open end 104 (FIG. 4A). The bag 100 may be sealed by adhering the inner front wall to the inner back wall via adhesive 130 (FIG. 4B), and the food transported from, for example, a restaurant to a customer via a delivery service. The customer can visually perceive if any damage to the bag is present prior to accepting the delivery from the delivery service, such as any tearing along the score line 140 and/or ripped inner or outer tube materials along or near the adhesive 130, thereby indicating that tampering with the bag may have occurred since the bag was sealed. The customer may then remove the upper portion of the bag, including the bag seal zone 150 and the handle 160, from the lower portion of the bag (FIG. 4C). The open end 104 of the shorter bag 100 having the upper portion removed, may be opened (FIG. 4D) and the contents of the bag removed for consumption.

With reference to FIGS. 5A-5E, the bag 100 may be constructed so the outer tube 110 and/or the inner tube 120 each comprise a plurality of layers or a single material. Other numbers of layers and/or combinations of materials used to form an insulated bag, including materials that are biodegradable and/or compostable, will be known to those of ordinary skill in the art and are to be considered within the scope of the present disclosure.

As described above, FIG. 5A depicts an embodiment wherein the outer tube 110 is bubble wrap with an outer layer 102a and an insulation layer 102b and the inner tube 120 is a metallized material layer 102c. However, as mentioned, the material of either the outer tube 110 or the inner tube 120 may comprise an air bubble packing material. The bubble film may, for example, have a low profile and the bubbles may be only several millimeters in diameter such as 3 mm to about 7 mm. In one embodiment, the bubble film has bubbles with a diameter that is about 5 millimeters.

In some embodiments, the layers may include at least one of a grease resistant material, a material with high durability, and a waterproof material. In an embodiment, the inner tube 120 includes at least one grease resistant barrier. In some embodiments, one or all of the layers may be formed from a biodegradable and a compostable material, such as paper, pulp, or polylactic acid (PLA). Additionally, in some embodiments, at least one layer comprises a metallized material, such a rolled aluminum foil. The layers may also include a metallized film that is a laminate of a polymer film such as mylar with a thin layer of metal such as aluminum. In some embodiments, the material of at least one of the outer tube 110 and the inner tube 120 is a metallized polymer, which may include aluminum. The metallized materials and metallized polymers are capable of reflecting heat radiation to preserve the temperature of the foods during transport. Examples of suitable metallized polymers include a metallized polyester or a metallized PLA. The metallized PLA film may, for example, be supplied by Celplast Metallized Products Limited such as their 80 ga (20 micron) metallized PLA film.

FIG. 5B depicts a further embodiment that is similar to the embodiment depicted in FIG. 5A but features an insulation layer 102e instead of the insulation layer 102b of the bubble wrap. Insulation layer 102e may comprise an insulating material instead of a structure that encapsulates air. FIG. 5B illustrates the three layers with the middle insulation layer 102e being thicker than the outer two layers. For example, the middle insulation layer 102e in FIG. 5C may be a foamed polymeric material sandwiched between an outer tube 110 such as a paper layer 102d and an inner tube 120, such as a grease resistant or water resistant material like a metallized film layer 102c.

FIG. 5C depicts an embodiment with four layers. An example of an embodiment with four layers is a polyethylene coating or layer 102f, a metallized film layer 102c, an insulation layer (depicted as a flat layer for simplicity) that may be bubble film 102b, and a white sealant film 102g. Each of these layers may comprise polyethylene-based materials. In the embodiment described with reference to FIG. 5C, the layers may have a total film gauge of about 4.35 mil including a polyethylene coating or layer, a 1.5 mil metallized film layer, a 1.5 mil bubble film with a low profile, and a 1.35 mil white sealant film.

A layer of the insulating material enhances the temperature retention in the inner portion of the bag 100 and can additionally reduce risk of damage to the bag structure. Other suitable insulating materials will be known to those skilled in the art and are to be considered within the scope of the present disclosure. In addition to the use of bubble wrap or bubble film other structures may be used that insulate by containing air including, crêpe paper having gathers to provide texture, and fluted corrugated sheets. FIG. 5D depicts crêpe paper 102h having gathers with a regular pattern on a metallized film layer 102c. However, the crêpe paper may also have gathers in an irregular pattern. The fluted corrugated sheets may, for example, be an E flute with 90+/−4 flutes per linear foot or an F flute with 125+/−4 flutes per linear foot.

FIG. 5E illustrates an embodiment of a bag having two layers. The material used for the outer tube 110 may be different from the material used for the inner tube 120, as shown, or they may be the same. FIG. 5E depicts an embodiment of an insulated bag having at least one paper layer 102h′ as an outer tube 110 and at least one polymeric layer as an inner tube 120 such as a metallized film layer 102c.

FIG. 5F shows a cross-section of a bag having a single tube made of a single material. The single layer 102i of the single tube may comprise any of the layers disclosed herein.

In some embodiments, each layer of the material used for the outer tube 110 and the inner tube 120 has a film gauge of about 1 mil to 3 mil, about 1.3 mil to about 2.5 mil, about 1.5 mil to about 2 mil, or about 1.5 mil.

FIG. 6 shows an insulated bag 200 having an outer tube 110, an inner tube 120, an adhesive 130, a score line 140, a bag seal zone 150, a handle 160, a plurality of vents 170, and a bag bottom 180. The insulated bag 200 includes four C-shaped vents 170, each of which extends through the outer front wall 113 and inner front wall 123. The vents 170 enable steam and/or condensation to be released from the bag and ensure that there is no pressure differential between the interior of the bag and the exterior environment. Each of the vents 170 may be formed as a C-shaped cut in the bag that extends through the entire front or entire back wall of the bag, thus allowing for air and other gases to get into or out of the bag.

For example, the vent may be a C-shaped cut or a D-shaped cut that extends through and along at least one of the outer front wall region and the outer back wall region. The material within the shaped cut may form a flap that remains attached to the wall of the bag in which it resides, such as illustrated in FIG. 7A. The flap, also known as a chad, may be easily pushed aside to allow for pressure equalization between the inside and outside of the bag, such as illustrated in FIG. 7B. Thus, the flap need not be completely removed from the bag.

Each of the vents 170 may be of any shape or size suitable for the bag. For example, each of the vents 170 may be a semi-circular slit formed by a rotary pinned perforation roller, a die and punch, or a laser cutter. In an embodiment, each of the vents 170 is formed by partially cutting a circle into the front and/or the back wall of the bag, the circle having a diameter between about 0.1 inches and about 1.5 inches, such as between about 0.2 inches and about 1.0 inches, or about 0.5 inches. The cut may completely penetrate the wall or may just score the wall by forming a weakened border such that the vent may be opened when desired. Each vent may be formed in a semi-circular shape that results from cutting about 60% of the circumference, about 70% of the circumference, about 80% of the circumference, or about 90% of the circumference of a circle into the bag wall. In an embodiment, each vent is a C-shaped vent that results from cutting about 80% of the circumference of a circle into the bag wall.

In certain embodiments, the vents 170 are shaped such and/or placed in a position such that hinders access to inner portions of the bag after the bag has been sealed via adhesive 130. For example, the size of each vent may not be large enough for an adult human finger to fit into the vent, or the vents may be placed high enough on the bag that access to the bottom of the bag is difficult. In some embodiments, the plurality of vents 170 may be positioned above (that is, toward the open end 104) the adhesive 130 and/or score line 140. The plurality of vents may be positioned above the bag seal zone 150. In an embodiment, the plurality of vents 170 are each C-shaped. In certain embodiments, the plurality of vents 170 are positioned between the score line 140 and the bag bottom 180. Other sizes, shapes and configurations of the vents will be known to those of ordinary skill in the art and are to be considered within the scope of the present disclosure.

The four C-shaped vents 170 of the embodiment of the bag 200 shown in FIGS. 6-7 are located on the outer tube front wall region 112, extending from the outer front wall 113 to the inner front wall 123, and placed between the handle 160 and the bag bottom 180. However, the number and placement of the plurality of vents 170 is not limited. The bag 200 may include a single vent 170 or a plurality of vents 170, which may be placed in varying locations on the front or back walls of the bag. For example, one embodiment of an insulated bag 200 having four vents 170, with a vent located in a line approximately equidistant from each other and from the edges of the front wall, is illustrated in FIG. 6. FIG. 8 shows an insulated bag 300 having three D-shaped vents 170 located adjacent and under three handles 160.

Other embodiments of insulated bags, such as those depicted in FIGS. 6 and 7A-7B as bag 200 and FIGS. 8-11 as bag 300, may resemble the bag 100 discussed above with respect to FIGS. 1-4D. It will be appreciated that the illustrated embodiments may have analogous features. Accordingly, like features are designated with like reference numerals, with the leading digits incremented to “1,” “2,” or “3”. Relevant disclosure set forth above regarding similarly identified features thus may not be repeated hereafter. Moreover, specific features of the bag and related components shown in FIGS. 5-15 may not be shown or identified by a reference numeral or specifically discussed in the written description that follows. However, such features may clearly be the same, or substantially the same, as features depicted in other embodiments and/or described with respect to such embodiments. Accordingly, the relevant descriptions of such features apply equally to the features of the bag 100, bag 200, bag 300, bag 400, bag 500, and bag 600. Any suitable combination of the features, and variations of the same, described with respect to the bag 100 and components illustrated in FIGS. 1-4 can be employed with the other bags and their components illustrated in FIGS. 6-15, and vice versa. This pattern of disclosure applies equally to further embodiments depicted in subsequent figures and described hereafter.

The insulated bags disclosed herein, such as bags 100, 200 and 300, include a closed end region 106 having the closed end 108 and the bag bottom 180. The bottom 180 may be of any be of any shape or size suitable for the bag. For example, the bottom 180 may be approximately rectangular in shape, or be hexagonal or octagonal. The bottom 180 may have rounded edges, such as being oval or circular in shape. In certain embodiments, the bottom 180 is adapted to stably rest upon a substantially planar surface, such as a tabletop or floor, when the bag is in an upright or standing position. The ability of the bag to stably rest upon a tabletop advantageously permits easy loading of items into the inner portions of the bag by, for example, a restaurant worker that is packing a take-out order for delivery.

The shape and size of the bag bottom 180 can vary, including to conform to the intended food products to be packaged. For example, a bag having a long and narrow bottom 180 would be suitable for packaging warm loaves of bread, as compared to a bag having a shorter and wider bottom 180 that may be suitable for packaging multiple containers of cold milk, ice cream, or warm hamburgers or soup.

With reference to FIGS. 4A-4D, in some embodiments, the bag bottom 180 may be configured or adapted to extend in approximately a single plane in a generally horizontal manner that it is substantially perpendicular to front walls 113, 123 and back walls 115, 125 when the bag 100 is in a standing open position. As illustrated in FIG. 4A, the bottom 180 can, in an embodiment, be approximately rectangular in shape and configured to stably rest upon a substantially planar surface. Embodiments of the insulated bags disclosed herein may include a plurality of gussets in addition to a front and back wall, such as illustrated in FIGS. 14 and 15 respectively at 597 and 697, and the bottom of the bag may be approximately hexagonal or circular in shape.

The bag bottom 180 may be of any strength and thickness suitable for the bag 100. The bottom 180 may be made with the same materials used for the outer and/or inner tube, or it may be made with different and/or additional materials. For example, the bottom 180 may include a stiff material to add rigidity and/or strength to the bag 100. The outermost layer of bottom 180 may include a waterproof material or a tear-resistant material. The bottom 180 may include a cupped or bowl-shaped material to contain spills or moisture that may be released from the contents of the bag.

In an embodiment, the bag bottom 180 is made of the same materials as the outer tube 110 and inner tube 120. The bottom 180 is, in some embodiments, rectangular and has a length between about 12 inches and about 36 inches, such as between about 18 inches and about 24 inches. The bottom 180 may have a width between about 6 inches and about 12 inches, such as between about 8 inches and about 10 inches.

Embodiments of the insulated bags disclosed herein may also include an additional adhesive 190 that is typically a releasable or removable adhesive that adheres the inner front wall of the bag to the inner back wall of the bag such that the inner front and back walls may be repeatedly and easily stuck and unstuck together. The additional adhesive 190 is configured to temporarily adhere the surfaces to which it is attached, and is typically has weak adhesive strength. Thus, the additional adhesive 190 is configured to form a substantially reversible seal between the front and back walls of the bag, in contrast to the substantially irreversible seal of the adhesive 130. The reversible closure of additional adhesive 190 involves adhesion of the inner front wall 123 to the inner back wall 125 (and of any gussets, if present, in some embodiments) such that the inner front and back walls are readily separable without damage to the bag. Thus, the additional adhesive 190 allows the inner surfaces of the inner front wall region 122 and inner back wall region 126 to readily and easily peelingly separate and unseal the inner surfaces of the inner front wall region 122 and inner back wall region 126 without significant or substantial damage to the inner surfaces when opening the bag. The adhesive may be a polyurethane such as those sold by Morchem.

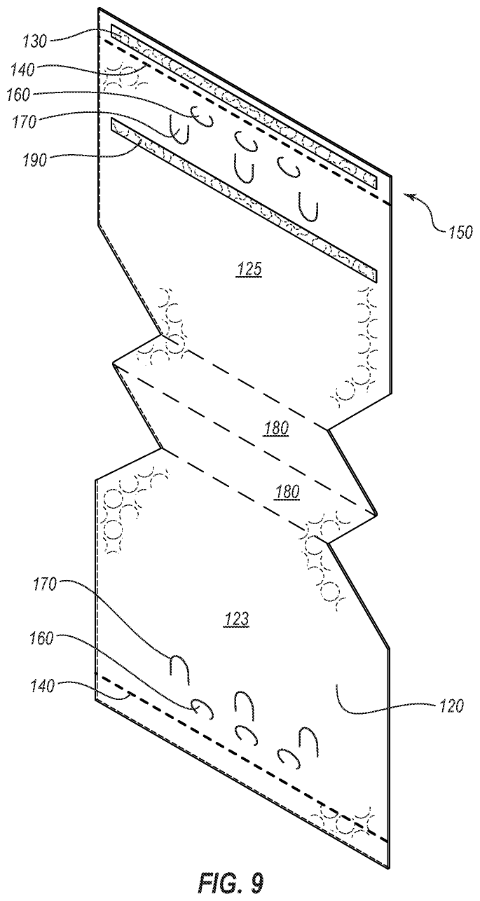

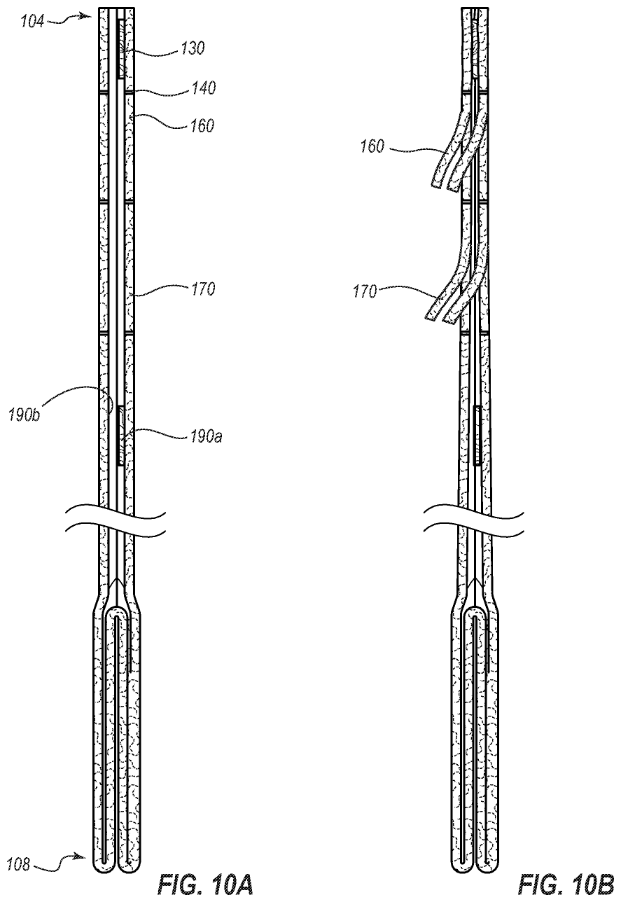

Insulated bag 300 as illustrated in FIGS. 8-12G is an embodiment that includes an additional adhesive 190. FIGS. 8 and 10A-B show the bag 300 in a closed, unsealed position. FIG. 9 shows the bag 300 in an extended and flattened view, with the edges unfastened and looking down upon the inner tube, showing the additional adhesive 190 placed along the inner back wall 125 below the handles 160 and vents 170. FIG. 10A is a side view of the bag 300 in cross-section of showing the handle and vents collinear with the bag, and FIG. 10A illustrates how the bottom of the handle and vent chads may be pushed out slightly from the bag.

The additional adhesive 190 may be a pressure-sensitive adhesive and is typically placed only on one of the inner front wall region 122 or inner back wall region 126, such as shown in FIG. 9. The additional adhesive 190 may be applied in a linear form, such as an adhesive strip having a protective sheet of material placed upon it so that the adhesive is not inadvertently exposed until removal of the protective sheet. The additional adhesive may be placed below (that is, toward the bottom 180) the adhesive 130 and score line 140. In this manner, the additional adhesive 190 may be used as a closure that is non-tamper evident, such as after the tamper evident seal (that is, the sealed adhesive 130 and the bag walls to which it is attached) has been removed via tearing along the score line 140. Thus, the bag may be reused multiple times even after removal of the tamper evident seal, in its capacity as an insulated bag.

The additional adhesive 190 may be applied to the inner tube 120 of bag in any suitable format. The additional adhesive 190 may be generally placed and arranged as described for the adhesive 130. For example, the additional adhesive 190 may be adapted to extend substantially along the inner front wall region 122 and inner back wall region 126 of the bag 300. In an embodiment, the additional adhesive 190 may extend the partial lateral extent of and along the inner front wall region 122 and back wall region 126 of the bag 300. The adhesive may, in some embodiments, extend approximately half of the lateral extent of and along the inner front and back wall regions of the bag.

Because of the reversible nature of the additional adhesive 190, its adhesive strength is typically low. In some embodiments, the adhesive is a low-tack pressure-sensitive adhesive. Other manners of temporarily adhering the inner front and back wall regions of a bag will be known to those of ordinary skill in the art and are to be considered within the scope of the present disclosure.

The additional adhesive 190 may be positioned at any location in the inner tube 120 between the open end 104 of the bag 100 and the closed end 108. In an embodiment, the additional adhesive 190 is positioned adjacent the handle(s) 160. In certain embodiments, the additional adhesive is positioned adjacent the plurality of vents 170. In some embodiments, the additional adhesive 190 is positioned between the score line 140 and the bag bottom 180. The additional adhesive 190 may be positioned in a generally straight line that is parallel to the score line 140, and along a portion of the inner circumference of the open end 104. The center of the line of additional adhesive 190 may be placed between about 3 and about 8 inches below the open end 104 of the bag 300. For example, the center of the line of additional adhesive 190 may be positioned about 5 to about 7 inches below the open end 104 of the bag 300, such as about 6 inches below the open end 104. The adhesive may be any conventional adhesive that achieves the enables the bag to be reclosed and then opened again.

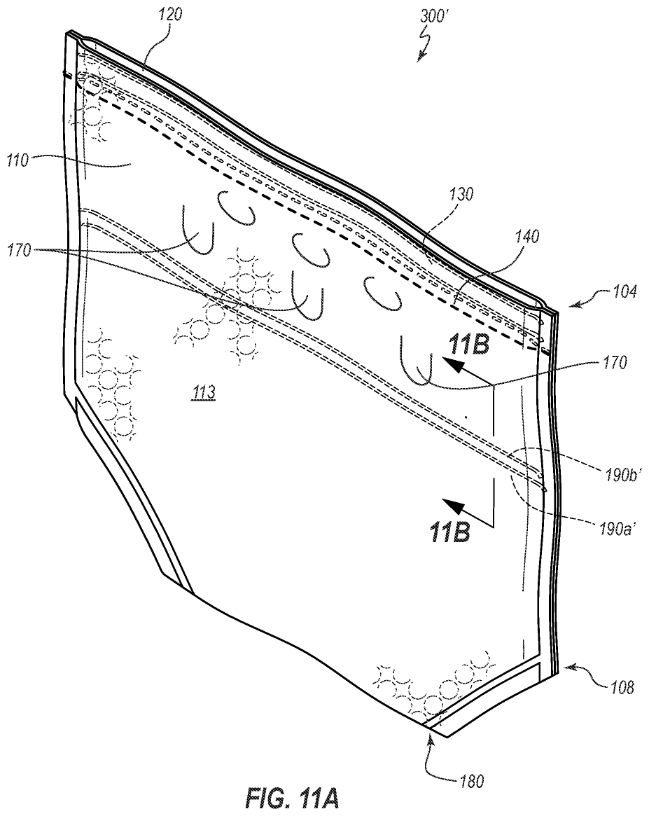

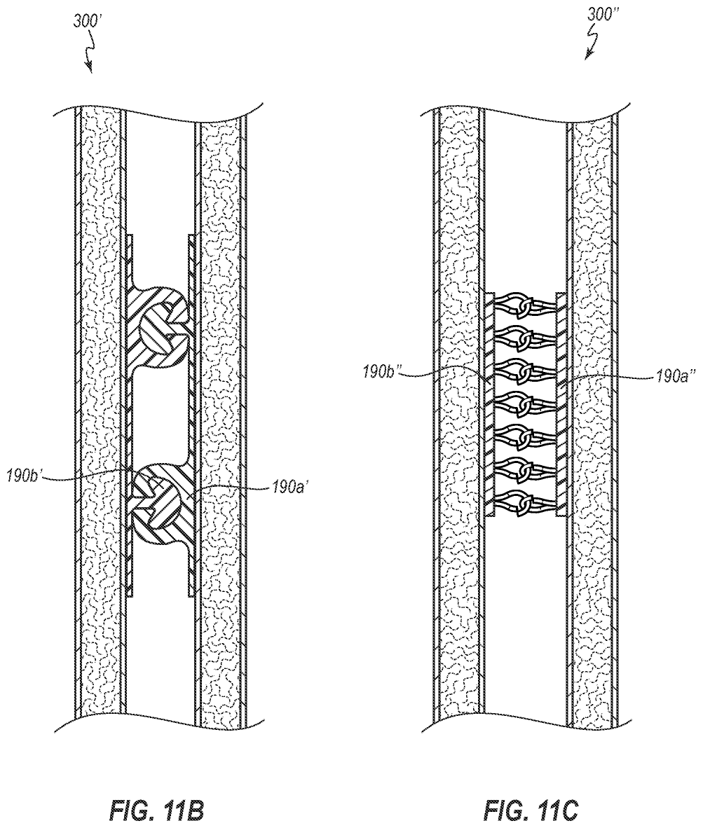

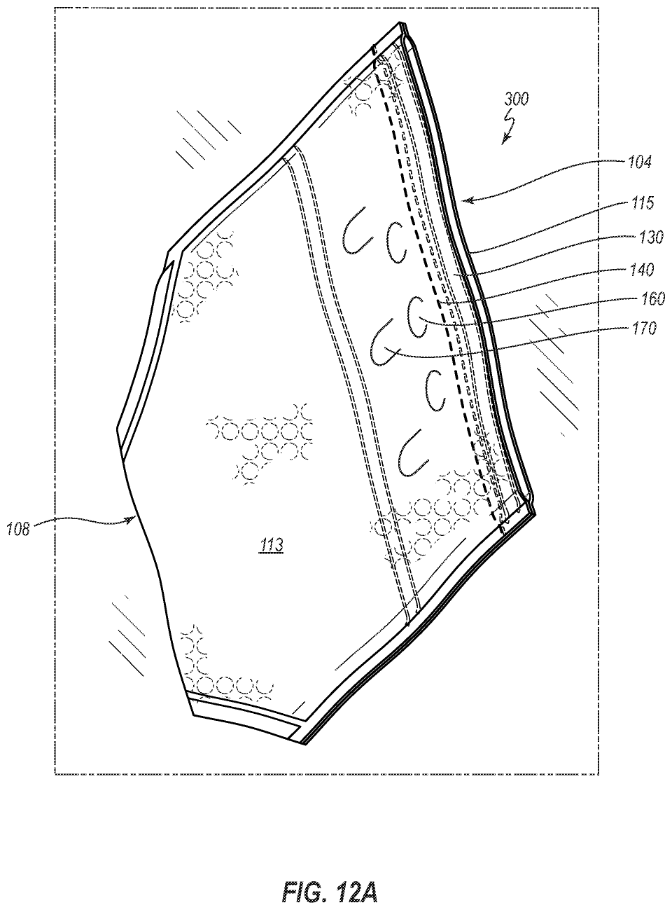

In other embodiments, the additional adhesive may be replaced by a mechanical recloseable feature. For example, the recloseable feature may comprise a plastic slider like Ziploc® zippers as shown in FIG. 11B. Additionally, the recloseable feature may comprise hook-and-loop fasteners such as Velcro® fasteners as shown in FIG. 11C.

Embodiments of the insulated bags disclosed herein advantageously include a tamper evident foldable bag that is configured to be flat when folded for storage after manufacturing, and may be unfolded for use when needed, such as at a restaurant. FIGS. 12A-12G illustrate an exemplary process for unfolding bag 300. The same or substantially similar process may be used for different embodiments of the insulated bags disclosed herein, including bags 100, 200, 400, 500, and 600.

With reference to FIG. 12A, the bag 300 may be positioned in a closed and flat position. In this position, the bag 300 has the bag bottom 180 and the bag front walls 113, 123 and back walls 115, 125 all substantially within the same plane. As such, multiple bags 300 may be stacked and stored in a space-efficient manner until used, such as by a restaurant for delivery of food. The bag bottom 180 may be extended out of this initial plane, such as by extending it to a position that permits the bag to stably rest upon a substantially planar surface such as a tabletop or floor, such as shown in FIG. 12B. The bag front walls 113, 123 and back walls 115, 125 may then be positioned substantially perpendicular to the bag bottom 180 by, for example, a user putting their hands into the open end 104 of bag 300 and manually pushing the front and back walls apart from each other. Such positioning of the front and back walls provides access to the inner portion of the bag prior to placement of items into the bag, and prior to adhesion of the inner front and back walls via adhesive 130.

The adhesive 130 may be applied to the bag as an adhesive strip that is positioned adjacent the open end 104 of the outer layer of the bag 300. The adhesive strip is configured to have an open position and a sealingly closed position. In the open position, in which the adhesive 130 is not substantially adhering the inner front wall 123 to the inner back wall 125 of the bag 300, the inner portion of the bag 300 is accessible and a user may readily place items therein, such as shown in FIG. 12B. In the closed position, in which the inner front wall 123 and the inner back wall 125 abuttingly contact and are adhered to each other, the inner front wall 123 is adhered to the inner back wall 125 in a substantially irreversible manner.

After placing items such as a container of hot or cold food into the inner portion of the bag 300, the open end 104 of bag 300 may be closed and sealed by adhering the inner front wall 123 to inner back wall 125 using adhesive 130, such as shown in FIG. 12C. This adhesion of the front and back walls 123, 125 seals the bag 300 and prevents ready access of the inner portion of the bag 300 such that the bag 300 cannot be opened without substantial damage to the inner front and back wall regions 122, 126, thereby indicating that the open end 104 of bag 300 may have been tampered with after sealing.

The tamper evident seal of bag 300 may be removed by tearing along score line 140 to separate the upper portion of the bag 300 from the lower portion of the bag that contains the food items, such as shown in FIG. 12D. The removal of the tamper evident seal permits ready access to the contents, as shown in FIG. 12E. Although the tamper evident seal has been removed from the bag 300 at this point, the bag 300 may be reused to store or transport hot or cold items either without a seal to secure the front and back walls 123, 125, or by using additional adhesive 190 to close the bag 300, as is shown in FIGS. 12F and 12G.

According to another embodiment of the disclosed insulated bags, the bag can be altered, for example, by forming a bag body having a plurality of material layers that form the inner tube and outer tube as described above. The bag body has at least one inner layer of material and at least one outer layer of material positioned to substantially surround outer surfaces of the inner layer of material. In an embodiment, the inner layer includes an insulating material and the outer layer includes a printable material. The printable material may be, for example, a metallized polymer such as polyester, paper, or a combination of a metallized polyester and paper. In some embodiments, the outer layer may include an insulating material. In one embodiment, the inner layer may include an insulating material, such as a metallized polymer. Any one or both of the inner or outer layer may include a biodegradable and/or compostable material. The bag may include an insulating outer or inner layer formed with an air bubble packing material.

As described above for specific embodiments of the bags, such as bag 100 and with reference to FIGS. 1-4D, the bag body has a pair of opposing bag ends, an open end 104 and a closed end 108, an outer front wall region 112 positioned between the pair of opposing bag ends 104 and 108, and an outer back wall region 115 positioned to face opposite the outer front wall region 112 and between the pair of opposing bag ends 104, 108.

The bag, as best seen in FIGS. 1 and 2, includes an inner layer having an inner front wall region 122 with an inner front wall 123, an inner back wall region 126 with an inner back wall 125 opposite the inner front wall 123, and an outer layer surrounding the inner layer. The outer layer has an open end 104 configured to have an open position and a closed position, a bag bottom 180 that is configured to stably rest upon a substantially planar surface, an outer front wall 113 positioned between the open end 104 and the bag bottom 180, and an outer back wall 115 positioned between the open end 104 and the bag bottom 180 and opposite the outer front wall. When the open end 104 of the bag 100 is in the open position, the inner portion of the bag is accessible, and when the open end 104 is in the closed position, the inner front wall 123 abuts the inner back wall 125, to close the bag and thereby restrict access to the inner portion of the bag.

The bag 100, in certain embodiments, includes a first adhesive 130 positioned adjacent the open end 104 of the outer layer, the first adhesive 130 adapted to extend substantially the entire lateral extent of and along the inner front and back walls 123, 125, and configured to substantially irreversibly seal the inner front wall 123 to the inner back wall 125. The bag 100 may include a score line 140 adjacent the first adhesive 130 and extending through and along substantially the entire lateral extent of the outer front and back walls 113, 115. The bag 100 may further include a handle 160 positioned between the score line 140 and the bag bottom 180, extending through and along the outer front and back walls 113, 115. The bag 100 may also include a plurality of C-shaped vents positioned between the handle 160 and the bag bottom 180, extending through and along at least one of the outer front wall 113 or back wall 115. The bag 100 may include a second adhesive 190 positioned adjacent the handle 160 and adapted to extend along the inner front wall 123 and the inner back wall 125, and configured to substantially reversibly seal the inner front wall 123 to the inner back wall 125. Embodiments of the bag 100 may also include a viewing window 195 in one of the outer front wall 113 and outer back wall 115.

Embodiments of the insulated bags disclosed herein, such as bag 400 shown in FIG. 13, may also include a viewing window 195 that is typically positioned in the front wall of the bag and extends through the outer front wall 113 and the inner front wall 123 of the bag 400 such that contents within the interior of the bag are visible from the outside after the bag has been sealed via adhesive 130. The viewing window 195 may be particularly useful after loading and sealing of the bag 400 at a restaurant, so that the correct number of containers of a food order may be confirmed prior to delivery to the end user/customer.

As shown in FIG. 13, the viewing window 195 may be configured to permit viewing of the bag contents while also maintaining the tamper-evident integrity of the bag 100. Thus, for example, the viewing window may be formed of materials that are semi-opaque or clarified rather than completely transparent, and that are resistant to tearing. The materials used to form the viewing window 195 may be the same as, or may be different from, the materials used to form the bag 100. The viewing window 195 may be of any shape or size suitable for the bag. The viewing window 195 is typically a rectangular shape placed in the front wall of the bag 400, having a length between about 3 inches and about 10 inches and a height between about 3 inches and about 8 inches.

The viewing window 195 may be positioned between the bag bottom 180 of the bag 400 and the open end 104. For example, the viewing window 195 may, in some embodiments, be placed adjacent the bag seal zone 150 and/or adjacent the bag bottom 180. In an embodiment, the bottom of the viewing window 195 is positioned between about 2 inches to about 5 inches above (that is, toward the open end 104) the bag bottom 180, and the top of the viewing window 195 is positioned between about 2 inches to about 5 inches below (that is, toward the closed end 108) the score line 140.

In an embodiment, the bag 100 includes a viewing window 195 that is formed by manufacturing a laminate. This process comprises the step of extrusion laminating, onto a first material perforated by a hole for and defining a viewing window 195, a heat-sealable second material. The layer of second heat-sealable plastic material is spaced from the layer of first material by thermoplastic layer deposited by extrusion between the layer of first material and the layer of second material in a manner such that the window is hermetically sealed by plastic through which the contents of a bag produced from the laminate may be viewed. The second material may comprises a 110 gauge (26 micron) transparent barrier film sold by Exxon Mobil as product 110AXT under the trade-mark BICOR, which has been laminated, by a solvent-based adhesive, to a 1 mm transparent sealant film sold by Pliant Corporation as product IO29. The intermediate layer may comprise low density polyethylene (LDPE). Other suitable thermoplastics for the intermediate layer include but are not limited to PE, LLDPE, MDPE, EVA, EMA, EAA and HDPE. Examples of laminates used to form a viewing window are disclosed in U.S. Pat. No. 9,498,930, which is hereby incorporated by reference.

Embodiments of the insulated bags disclosed herein may also include a plurality of gussets (also known as side walls) between the front and back walls of the bag that may permit the bag to have a larger volume, to readily contain boxy food containers (such as, for example, a 6-pack of an ethanolic beverage), and/or add strength to the bag. For example, as illustrated in FIG. 14, bag 500 includes a pair of gussets 597. An insulated bag 500 having plurality of gussets 597 is advantageously provided as another embodiment of the present disclosure. The bag 500 may include an outer tube 110, an inner tube 120, an adhesive 130, a score line 140, a handle 160, vents 170, a bag bottom 580 and a pair of gussets 597.

The material used to form the gussets 597 may be the same as, or may be different from, the materials used to form the inner and/or outer tubes of bag 500. The gussets 597 may be of any shape or size suitable for the bag 500. The gussets 597 typically have a rectangular or triangular shape, having a height that matches the height of the bag 500 and a width between about 3 inches and about 10 inches. The open end 104 of an embodiment of a gusseted bag having triangular gussets may not be substantially changed as compared to that of a non-gusseted bag. The open end 104 of an embodiment of a gusseted bag having rectangular gussets, such as bag 500 shown in FIG. 14, will be enlarged by the gussets. The shape of closed end 108 and bag bottom 180 in a gusseted bag will differ as compared to a non-gusseted bag. Other sizes and shapes of gussets for a bag will be known to those of ordinary skill in the art and are to be considered within the scope of the present disclosure.

The gussets 597 are preferably formed between the outer front wall region 112 and the outer back wall region 116 of the insulated bag 500. At least a first one of the plurality of gussets 597 is formed in a first region between the outer front and back wall regions so as to define a first outer side wall region. At least a second one of the plurality of gussets 597 is formed in a second region between the outer front and back wall regions so as to define a second outer side wall region. The second side wall region is positioned opposite the first outer side wall region. Insulated bags that include a plurality of gussets 597 may exhibit increased drop and abuse resistance of the bag 500.

FIG. 15 depicts bag 600, which has a flat bag bottom 680. The other components of bag 600 include many that are the same as those of bag 100 as depicted in FIG. 1 including an outer tube 110 with an outer front wall region 112, an inner tube 120, an adhesive 130, a score line 140, a bag seal zone 150, and a handle 160. The bag 600 has an open end region 102 with an open end 104 and a closed end region 106 with a closed end 108. Bag 600 has a rectangular cross-section and the flat bag bottom 680 is rectangular. Bag 600 has a gusset 697 at its opposing short sides. Gussets have a rectangular shape but may have any shape that enables bag 600 to be in a collapsed position and then transition to enable bag 600 to be upright.

Bag 600 may have any combination of layers disclosed herein like the other bags disclosed herein. Bag 600 may also have an outer tube and an inner tube that is a single material such as the single layer 102i disclosed in FIG. 5F.

It is envisioned that the insulated bags disclosed herein can be used for any type of product that may benefit from having a tamper evident seal. Such uses include bags for various food items and other uses as will be known to one skilled in the art and are to be considered within the scope of this disclosure.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers. For example, where the term “substantially planar” is recited with respect to a feature, it is understood that in further embodiments, the feature can have a precisely planar configuration.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the preceding claims up to and including claim [x],” where the bracketed term “[x]” is replaced with the number of the most recently recited independent claim. For example, for the first claim set that begins with independent claim 1, claim 3 can depend from either of claims 1 and 2, with these separate dependencies yielding two distinct embodiments; claim 4 can depend from any one of claim 1, 2, or 3, with these separate dependencies yielding three distinct embodiments; claim 5 can depend from any one of claim 1, 2, 3, or 4, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed in accordance with 35 U.S.C. § 112 ¶ 6. Embodiments of the invention in which an exclusive property or privilege is claimed are defined as follows.

1. A tamper-evident insulated bag comprising:
an inner tube comprising a compostable first material and including an inner front wall region and an inner back wall region positioned to face opposite the inner front wall region, the first material comprising polylactic acid;
an outer tube comprising a compostable second material and positioned to substantially surround outer surfaces of the inner tube, the outer tube having an open end region, a closed end region comprising a bag bottom that is configured to stably rest upon a substantially planar surface, an outer front wall region positioned between the open end region and the closed end region, and an outer back wall region positioned between the open end region and the closed end region and positioned to face opposite the outer front wall region, the second material comprising paper;
a bag seal zone positioned adjacent the open end of the outer tube and positioned so that the compostable first material of inner surfaces of the inner front wall region of the inner tube abuttingly contacts and seals to inner surfaces of the inner back wall region of the inner tube, the bag seal zone comprising an adhesive adapted to extend substantially the entire lateral extent of and along the inner front and back wall regions and to allow access to inner portions of the bag prior to adhesion of the inner front and back wall regions, the adhesive configured to irreversibly close the open end of the bag such that the bag cannot be opened without substantial damage to the inner front and back wall regions to thereby indicate that tampering with the open end of the bag may have occurred;
a score line adjacent the adhesive, extending through and along substantially the entire lateral extent of the outer front wall region and the outer back wall region;
a handle positioned between the score line and the bag bottom, extending through and along the outer front wall region and the outer back wall region; and
a plurality of C-shaped vents positioned between the score line and the bag bottom, extending through and along at least one of the outer front wall region and the outer back wall region.

2. The tamper-evident insulated bag of claim 1, wherein at least one of the outer front wall region and the outer back wall region comprises a viewing window.

3. The tamper-evident insulated bag of claim 1, wherein the compostable first material is a food-grade material.

4. The tamper-evident insulated bag of claim 1, wherein the plurality of C-shaped vents are adjacent the handle.

5. The tamper-evident insulated bag of claim 1, further comprising an additional adhesive positioned so that inner surfaces of the material of the inner front wall region are reversibly sealed to the inner surfaces of the back wall region and peelingly separate to unseal the inner surfaces of the inner front and back wall regions without substantial damage thereto.

6. The tamper-evident insulated bag of claim 5, wherein the additional adhesive is adjacent the handle.

7. The tamper-evident insulated bag of claim 5, wherein the additional adhesive is positioned between the handle and the closed end region of the bag.

8. A tamper-evident insulated bag comprising:
an inner tube comprising air bubble packing material and including an inner front wall region and an inner back wall region positioned to face opposite the inner front wall region;
an outer tube comprising a metallized material and positioned to substantially surround outer surfaces of the inner tube, the outer tube having an open end region, a closed end region comprising a bag bottom that is configured to stably rest upon a substantially planar surface, an outer front wall region positioned between the open end region and the closed end region, and an outer back wall region positioned between the open end region and the closed end region and positioned to face opposite the outer front wall region;
a bag seal zone positioned adjacent the open end of the outer tube and positioned so that the air bubble packing material of inner surfaces of the inner front wall region of the inner tube abuttingly contacts and seals to inner surfaces of the inner back wall region of the inner tube, the bag seal zone comprising an adhesive adapted to extend substantially the entire lateral extent of and along the inner front and back wall regions and to allow access to inner portions of the bag prior to adhesion of the inner front and back wall regions, the adhesive configured to irreversibly close the open end of the bag such that the bag cannot be opened without substantial damage to the inner front and back wall regions to thereby indicate that tampering with the open end of the bag may have occurred;
a score line adjacent the adhesive, extending through and along substantially the entire lateral extent of the outer front wall region and the outer back wall region;
a handle positioned between the score line and the bag bottom, extending through and along the outer front wall region and the outer back wall region; and
a plurality of C-shaped vents positioned between the score line and the bag bottom, extending through and along at least one of the outer front wall region and the outer back wall region.

9. The tamper-evident insulated bag of claim 8, wherein at least one of the outer front wall region and the outer back wall region comprises a viewing window.

10. The tamper-evident insulated bag of claim 8, wherein the plurality of C-shaped vents are adjacent the handle.

11. The tamper-evident insulated bag of claim 8, further comprising an additional adhesive positioned so that inner surfaces of the material of the inner front wall region are reversibly sealed to the inner surfaces of the back wall region and peelingly separate to unseal the inner surfaces of the inner front and back wall regions without substantial damage thereto.

12. The tamper-evident insulated bag of claim 11, wherein the additional adhesive is adjacent the handle.

13. The tamper-evident insulated bag of claim 11, wherein the additional adhesive is positioned between the handle and the closed end region of the bag.

14. A tamper-evident foldable bag comprising:
an inner layer comprising an insulating material and having an inner front wall and an inner back wall opposite the inner front wall;
an outer layer comprising a printable material and surrounding the inner layer, the outer layer having an open end configured to have an open position and a closed position, a bag bottom that is configured to stably rest upon a substantially planar surface, an outer front wall positioned between the open end and the bag bottom, and an outer back wall positioned between the open end and the bag bottom and opposite the outer front wall; wherein when the open end is in the open position, the inner portion of the bag is accessible, and wherein when the open end is in the closed position, the inner front wall abuts the inner back wall;
a first adhesive positioned adjacent the open end of the outer layer, the first adhesive adapted to extend substantially the entire lateral extent of and along the inner front and back walls, the first adhesive configured to substantially irreversibly seal the inner front wall to the inner back wall;
a score line adjacent the first adhesive and extending through and along substantially the entire lateral extent of the outer front and back walls;
a handle positioned between the score line and the bag bottom, extending through and along the outer front and back walls;
a plurality of C-shaped vents positioned between the handle and the bag bottom, extending through and along at least one of the outer front or back walls; and
a second adhesive positioned adjacent the handle and adapted to extend along the inner front wall and the inner back wall, the second adhesive configured to substantially reversibly seal the inner front wall to the inner back wall;
wherein the bag is configured to fold into a flat position and unfold into a standing position,
wherein transitioning the bag from the flat position to the standing position includes
(1) extending the bag bottom to a position that permits the bag to stably rest upon a substantially planar surface, and
(2) positioning the front and back walls substantially perpendicular to the bag bottom thereby opening the bag to provide access to the inner portion of the bag, and
wherein sealing the bag comprises adhering the inner front wall to the inner back wall via the first adhesive such that the bag cannot be opened without substantial damage to the inner front and back wall regions to thereby indicate that tampering with the bag may have occurred.

15. The tamper-evident foldable bag of claim 14, wherein at least one of the outer walls comprises a viewing window.

16. The tamper-evident foldable bag of claim 14, wherein the insulating material comprises an air bubble packing material.

17. The tamper-evident foldable bag of claim 14, wherein the insulating material comprises a compostable material.

18. The tamper-evident foldable bag of claim 14, wherein the printable material comprises a metallized polyester, paper, or a combination of a metallized polyester and paper.
